(19) United States
(12) Patent Application Publication
(10) Pub. No.: US 2009/0248760 A1
(43) Pub. Date: Oct. 1, 2009

(54) BACKUP METHOD OF COMPUTER SYSTEM

(75) Inventors: Minoru Tone, Kawasaki (JP); Hisayuki Enbutsu, Kawasaki (JP); Takashi Akiyama, Kawasaki (JP)

Correspondence Address: GREER, BURNS & CRAIN, 300 S WACKER DR, 25TH FLOOR, CHICAGO, IL, 60606, US

(73) Assignee: FUJITSU LIMITED, Kawasaki-shi (JP)

(21) Appl. No.: 12/408,691

(22) Filed: Mar. 21, 2009

(30) Foreign Application Priority Data
Mar. 27, 2008 (JP) 2008-83339

(51) Int. Cl. G06F 12/16; G06F 12/00

(52) U.S. Cl. 707/204; 707/E17.044; 711/E12.001; 711/E12.103

(57) ABSTRACT

A backup method of a computer system capable of recovery independently by a backup center alone, even if reorganization of a DB cannot be completed due to a disaster of some kind.

### CROSS-REFERENCE TO RELATED APPLICATION

This application is based upon and claims the benefit of priority of the prior Japanese Patent Application No. 2008-83339, filed on Mar. 27, 2008, the entire contents of which are incorporated herein by reference.

### FIELD

An embodiment of the present invention relates to a backup method of a computer system using a database.

### BACKGROUND

In a large-scale system typically represented by a social system, the scale of a database is large and the amount of data needed to update the database is also large. Since storage efficiency of such a database goes down, it is necessary to periodically reorganize the database through operation.

However, if a backup method in which a computer system (hereinafter, referred to as a “regular center”) is backed up in a backup system (hereinafter, referred to as a “backup center”) set up in a remote place is adopted and a database is reorganized in the regular center, it is necessary to convey save data of the database after the reorganization and definition information to the backup center to restore the saved data and definition information in the database of the backup center.

FIG. 6 is a diagram illustrating a conventional example of the backup method of a computer system.

A regular center 600 updates a DB (database) 602 by a DB update unit 601 when necessary. At the same time, the regular center 600 stores in a DISK device 603 an update history file in which an update history log is stored.

When the regular center 600 reorganizes the database 602 by a DB reorganization unit 604, the regular center 600 saves data of the database 602 after the reorganization and management information generated during reorganization and stored in a directory 605 (hereinafter, both types of data are generally called “save data”) in storage devices 606 and 607 respectively.

Then, the regular center 600 conveys or remotely transfers the save data to a backup center located in a remote place.

A backup center 610 updates a DB 613 by a DB reflection unit 616 according to the update history log of the update history file remotely copied from the regular center 600 to a DISK device 615. When the save data is conveyed or remotely transferred from the regular center, the backup center 610 stores the save data in storage devices 611 and 612. Then, the backup center 610 suppresses an update of the DB 613 by the DB reflection unit 616 and performs a series of operations such as restoring the save data to the DB 613 and a directory 614.

In the backup center 610, as described above, it is necessary to grasp/manage timing of DB reorganization on the side of the regular center 600 and to suppress an update of the DB 613 when necessary. For example, when an update history file (update history log) after reorganization is transferred from the regular center 600, it is necessary to suppress reflection of the update history log in the DB 613 until reorganization processing on the side of the backup center 610 is completed.

Thus, if reorganization on the side of the backup center 610 cannot be completed due to, for example, a disaster, an update history log that is accumulated on the side of the backup center 610 and not yet reflected will all be lost data.

If processing is stopped halfway through reorganization due to, for example, a disaster, consistency of the DB 613 cannot be guaranteed and thus, it is necessary to perform processing such as restoring the DB 613 based on the previous backup data.

An online system that eliminates the need for storing information into a check point file and improves performance of the reorganization process is disclosed in Japanese Examined Patent Application Publication Number 6-348553.

An online system that improving reliability and performance of database reorganization by synchronizing with a plurality of center systems is disclosed in Japanese Laid-Open Patent Publication Number 10-333946.

### SUMMARY

According to an aspect of the present invention, a backup method of an information processor includes:

performing reorganization operation information generation processing to perform reorganization of a database by performing predetermined operations on the database and to generate reorganization operation information recording the predetermined operations before the reorganization operation information being stored in a first reorganization operation information storage unit; and

performing transmission processing to read reorganization operation information from the first reorganization operation information storage unit to transmit the read reorganization operation information in a regular center, which is an operating information processor equipped with a database to perform any information processing, and

performing reception processing to receive reorganization operation information transmitted from the regular center to store the reorganization operation information in a second operation information storage unit;

performing reorganization continuation determination processing to read the reorganization operation information from the second operation information storage unit and to reference the predetermined operations recorded in the reorganization operation information to determine whether or not reorganization of the database performed in the regular center can be performed based on the predetermined operations; and

performing reorganization processing to perform reorganization of the database according to the predetermined operations recorded in the reorganization operation information when a determination is made in the reorganization continuation determination processing that reorganization of the database can be performed, and to complement any missing predetermined operation to perform reorganization if a portion of the predetermined operations recorded in the reorganization operation information is missing in a backup center, which is a standby information processor the regular center.

The object and advantages of the embodiment will be realized and attained by means of the elements and combinations particularly pointed out in the claims.

It is to be understood that both the foregoing general description and the following detailed description are exemplary and explanatory and are not restrictive of the embodiment, as claimed.

### BRIEF DESCRIPTION OF THE DRAWINGS

FIG. 1 is a diagram illustrating an outline of a backup method according to an embodiment of the invention;

FIG. 2 is a diagram illustrating a concrete example of DB reorganization processing according to an embodiment;

FIG. 3 is a diagram illustrating a configuration example of an update history file according to an embodiment;

FIG. 4 is a diagram illustrating a configuration example of block data illustrated in FIG. 3;

FIG. 5 is a flow chart illustrating concrete processing in a backup center according to an embodiment; and

FIG. 6 is a diagram illustrating a conventional example of the backup method of a computer system.

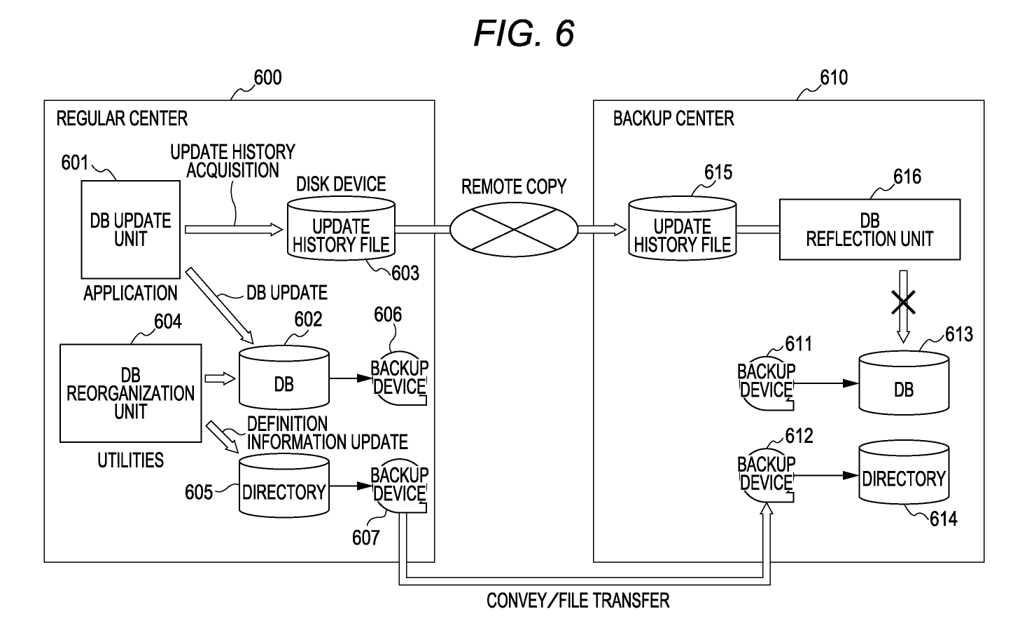

### DESCRIPTION OF THE EMBODIMENT

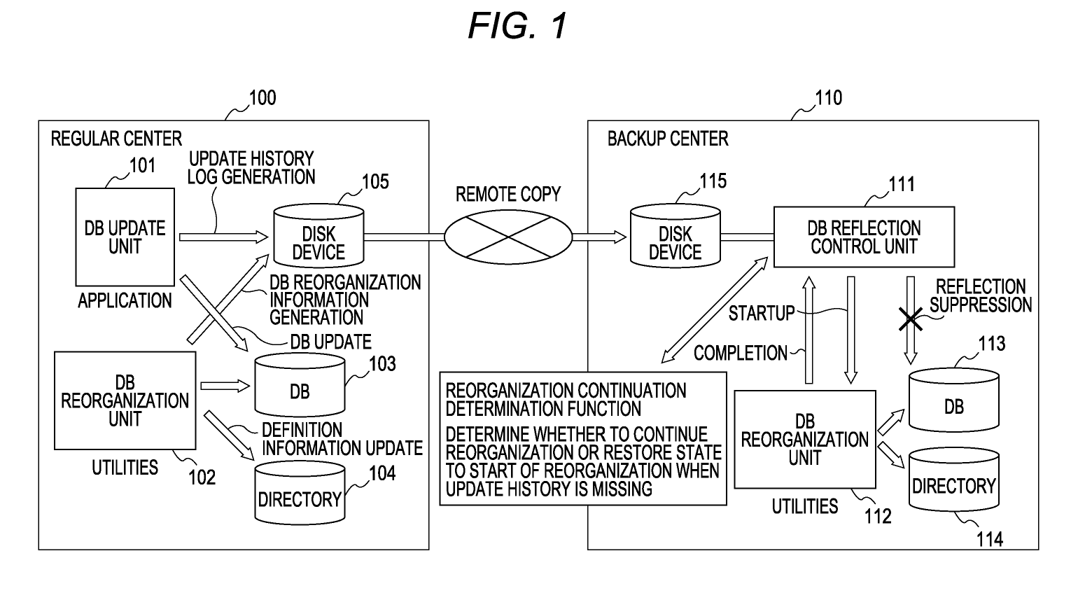

An embodiment of the present invention will be described below based on FIG. 1 to FIG. 5.

FIG. 1 is a diagram illustrating an outline of a backup method according to the present embodiment.

A regular center 100 is an operating information processor performing any kind of information process. A DB update unit 101 or a DB reorganization unit 102 is realized by a predetermined program being executed by a CPU held by the information processor.

The regular center 100 also includes a database (DB) 103 searchably managing/storing any kind of information, a directory 104 storing management information of the DB 103, and a DISK device 105 storing information (hereinafter, referred to as an “update history file”) at least including update history information of the DB 103 (hereinafter, referred to as a “DB update log”) and information about any operation on the DB 103 (hereinafter, referred to as a “DB history log”).

A backup center 110 is a standby information processor of the regular center 100. A DB reflection control unit 111 or a DB reorganization unit 112 is realized by a predetermined program being executed by a CPU held by the information processor.

The backup center 110 also includes a DB 113 searchably managing/storing any kind of information, a directory 114 storing management information of the DB 113, and a DISK device 115 storing an update history file transmitted from the regular center 100.

The regular center 100 and the backup center 110 are mutually communicably connected by a network or dedicated line. In the present embodiment, process of receiving, for example, an update history file stored in the DISK device 105 through communication between the regular center 100 and the backup center 110 and storing the update history file in the DISK device 115 is referred to as a remote copy.

In the regular center 100, the DB update unit 101 executes any information unit according to a predetermined program. Then, the DB update unit 101 updates content of the DB 103 when necessary. At this point, the DB update unit 101 generates an update history log recording update history of the DB update unit 101 and stores the update history log in the DISK device 105.

The DB reorganization unit 102 performs DB reorganization process of the DB 103 according to preset rules in accordance with instructions from users.

At this point, the DB reorganization unit 102 performs a predetermined operation on the DB 103 determined in accordance with the type of DB reorganization to be executed (predetermined instructions are caused to be executed on the DB 103). At the same time, a DB update log is generated by recording the predetermined operation (or a series of operations) performed and stored in an update history file stored in the DISK device 105. When an operation other than DB reorganization process is performed on the DB 103, the regular center 100 also generates a DB update log.

The regular center 100 remotely copies an update history file to the backup center 110 to store the update history file in the DISK device 115 of the backup center 110, for example, regularly or each time an update history file is generated.

The regular center 100 may simply transmit an update history file stored in the DISK device 105 to the backup center 110. In this case, when an update history file is received, the backup center 110 may store the update history file in the DISK device 115.

In the backup center 110, on the other hand, the DB reflection control unit 111 reads the update history file from the DISK device 115 and references a DB update log stored in the update history file. Then, the DB reflection control unit 111 determines whether or not the reorganization process of the DB 113 can be performed based on the DB update log.

If the DB reflection control unit 111 determines that DB reorganization process can be performed, the DB reflection control unit 111 stops update process of the DB 113 based on an update history log and instructs the DB reorganization unit 112 to perform the reorganization process.

The DB reorganization unit 112 performs a DB reorganization operation recorded in the DB update log recorded in the update history file to perform the reorganization process of the DB 113. If a portion of the DB update log is missing, the DB reorganization unit 112 completes DB reorganization process by performing a predetermined operation determined in accordance with the type of DB reorganization to be executed by complementing the missing portion.

If the DB reflection control unit 111 determines that the DB reorganization process cannot be performed, the DB reflection control unit 111 instructs the DB reorganization unit 112 to stop execution of the DB reorganization process. If the DB reorganization process is halfway through, the DB reflection control unit 111 instructs the DB reorganization unit 112 to roll back the DB 113 to a state before execution of the executed process. The DB reorganization unit 112 restores the state of the DB 113 to a state before starting the DB reorganization process according to instructions.

The regular center 100 and the backup center 110 described above may naturally be an information processing system (computer system) consisting of two or more information processors.

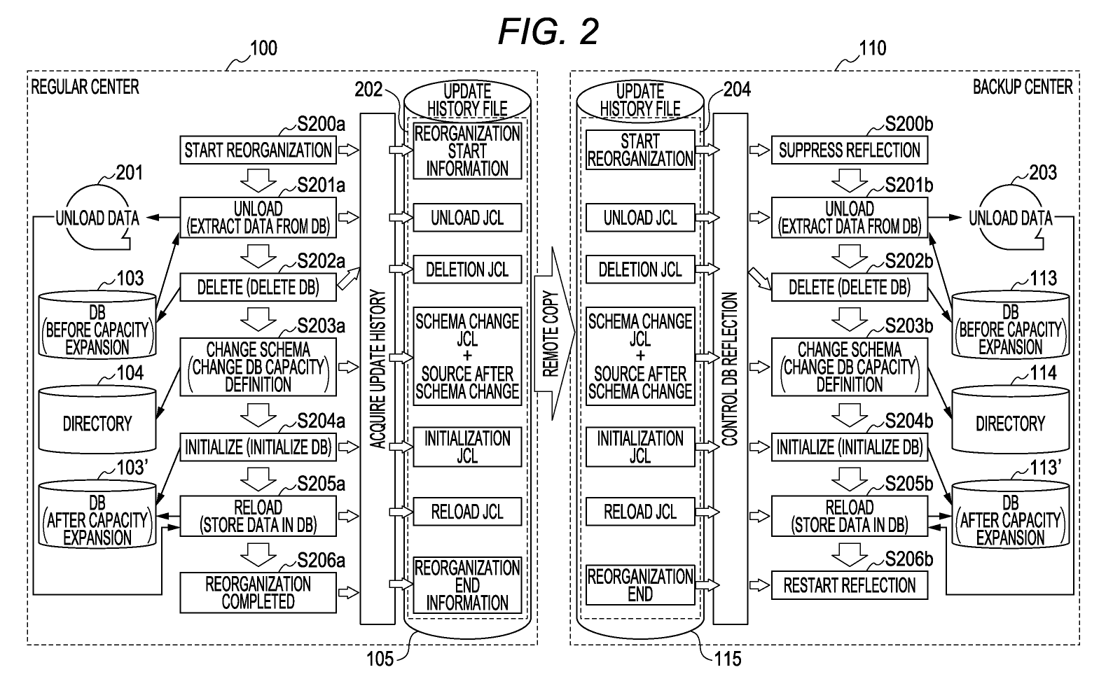

FIG. 2 is a diagram illustrating a concrete example of a DB reorganization process according to the present embodiment. In FIG. 2, a case of expanding capacities of the DB 103 is described as a concrete example of the DB reorganization process according to the present embodiment. However, the DB reorganization process according to the present embodiment is not intended to be limited to DB area extension process and, for example, the backup method according to the present embodiment is applicable also to a process such as defragmentation of the DB 103 and changes of schema.

When the DB reorganization process is started at step S200a, the DB reorganization unit 102 stores information (hereinafter, referred to as “reorganization start information”) such as the type of reorganization (in the example in FIG. 2, “DB capacity expansion”) and the start time of the reorganization process in an update history file (hereinafter, referred to as an “update history file 202”) stored in the DISK device 105 as an update history log.

At step S201a, the DB reorganization unit 102 performs an unload process of data stored in the DB 103. That is, the DB reorganization unit 102 extracts necessary data from data stored in the DB 103 and temporarily stores the necessary data in a storage device 201.

At this point, the DB reorganization unit 102 transmits one instruction or two or more instructions (hereinafter, referred to as a “JCL (Job Control Language)”) to perform a predetermined operation to the DB 103 to perform the unload process by causing the DB 103 to perform the JCL (hereinafter, the JCL at this time is referred to as an “unload JCL”). At the same time, the DB reorganization unit 102 stores the unload JCL in the update history file 202 as a DB update log.

At step S202a, after data of the DB 103 being saved in the storage device 201 by the process at step S201a, the DB reorganization unit 102 deletes content of the DB 103. At this point, the DB reorganization unit 102 transmits a predetermined JCL to the DB 103 to cause the DB 103 to perform the JCL (hereinafter, the JCL at this time is referred to as a “deletion JCL”) to delete the content of the DB 103. At the same time, the DB reorganization unit 102 stores the deletion JCL in the update history file 202 as a DB update log.

At step S203a, the DB reorganization unit 102 makes changes of a schema stored in the directory 104 needed for DB reorganization. In the example illustrated in FIG. 2, the DB reorganization unit 102 makes changes of the DB capacity definition and the like needed for DB capacity expansion.

At this point, the DB reorganization unit 102 transmits a predetermined JCL to the DB 103 to cause the DB 103 to perform the JCL (hereinafter, the JCL at this time is referred to as a “schema JCL”) to change the schema. At the same time, the DB reorganization unit 102 stores the schema JCL and a schema source after the change in the update history file 202 as a DB update log.

At step S204a, the DB reorganization unit 102 initializes the DB 103. At this point, the DB reorganization unit 102 transmits a predetermined JCL to the DB 103 to cause the DB 103 to perform the JCL (hereinafter, the JCL at this time is referred to as an “initialization JCL”) to initialize the DB 103. At the same time, the DB reorganization unit 102 stores the initialization JCL in the update history file 202 as a DB update log.

At step S205a, the DB reorganization unit 102 performs reload process of DB data. That is, the DB reorganization unit 102 stores the unload data temporarily stored in the storage device 201 in a DB 103′ obtained by expanding the capacity of the DB 103.

At this point, the DB reorganization unit 102 transmits a JCL of the process to the DB 103 to perform reload process by causing the DB 103 to perform the JCL (hereinafter, the JCL at this time is referred to as an “reload JCL”). At the same time, the DB reorganization unit 102 stores the reload JCL in the update history file 202 as a DB update log.

When the above process is normally completed, the DB reorganization unit 102 stores information (hereinafter, referred to as “reorganization end information”) such as the type (in the example in FIG. 2, “DB capacity expansion”) of reorganization whose DB reorganization process is completed and time in the update history file 202 as a DB update log before ending the DB reorganization process (step S206a).

After completing the DB reorganization process by executing all steps, the regular center 100 remotely copies the update history file 202 stored in the DISK device 105 to the DISK device 115 in the backup center 110. The update history file 202 may also be remotely copied to the DISK device 115 each time the process of each step is completed or regularly.

When the update history file 202 is remotely copied, the DB reflection control unit 111 references a concerned update history file 204. Then, the DB reflection control unit 111 references a JCL group recorded in the update history file 204 as DB update logs to determine whether or not the DB reorganization process can be performed.

Then, if the DB reflection control unit 111 determines that the DB reorganization process can be performed, the DB reflection control unit 111 starts the DB reorganization process in the backup center 110.

At step S200b, the DB reflection control unit 111 stops (suppresses) reflection of DB updates in the DB 113. That is, the DB reflection control unit 111 stops (suppresses) the process to update the DB 113 according to DB update logs recorded in the update history file 204.

Then, the DB reflection control unit 111 performs, as illustrated below, DB reorganization process performed in the regular center (step S201a to S206a) according to JCLs recorded in the update history file 204.

At step S201b, the DB reflection control unit 111 performs the unload process of data stored in the DB 113. That is, the DB reflection control unit 111 extracts necessary data from data stored in the DB 113 and temporarily stores the necessary data in a storage device 203 (not illustrated). At step S202b, after data of the DB 113 has been saved in the storage device 203 by the process at step S201b, the DB reflection control unit 111 deletes the content of the DB 113.

At step S203b, the DB reflection control unit 111 makes changes of the schema stored in the directory 114 needed for DB reorganization. In the example illustrated in FIG. 2, the DB reflection control unit 111 makes changes of the DB capacity definition and the like needed for DB capacity expansion.

At step S204b, the DB reflection control unit 111 initializes the DB 113.

At step S205b, the DB reflection control unit 111 performs the reload process of DB data. That is, the DB reflection control unit 111 stores the unload data temporarily stored in the storage device 203 in a DB 113′ obtained by expanding the capacity of the DB 113.

Here, if the DB reflection control unit 111 determines that a portion of JCL recorded in the update history file 204 is missing and DB reorganization process can be performed, the DB reflection control unit 111 completes the DB reorganization process by complementing the missing portion of the JCLs for performing the DB reorganization process.

For example, the type of DB reorganization process may be identified, for example, from reorganization start information recorded in the update history file 204 as a DB update log to acquire the relevant JCL (missing JCL) from a JCL group stored in a storage device or the like in advance each time the DB reorganization process is performed to perform the missing JCL.

In the example illustrated in FIG. 2, for example, if the initialization JCL, the reload JCL and the reorganization end information are missing in the update history file 204, the DB reflection control unit 111 can acquire JCLs (the initialization JCL and reload JCL) related to DB capacity expansion process from JCL group stored in advance in a storage device or the like for each type of DB reorganization process to perform steps S204b and S205b.

If the DB reflection control unit 111 determines that, because a portion of JCL recorded in the update history file 204 is missing, the DB reorganization process cannot be performed, the DB reflection control unit 111 performs a process to restore states of the DB 113, the directory 114 and the like changed by the process already performed to those before the process was performed.

In the example illustrated in FIG. 2, for example, if the process up to step S202b has been performed, unload data saved in the storage device 203 is reloaded to the DB 113 to restore the state of the DB 113 before terminating the DB reorganization process.

Here, whether or not the DB reorganization process can be performed can be determined, for example, based on whether or not JCLs concerning the main process of the DB reorganization process stored as DB update logs in the update history file 204 are contained in the update history file 204.

In the example illustrated in FIG. 2, for example, the type of DB reorganization process is DB capacity expansion and so, whether or not a schema change JCL and a schema source after the change are contained in the update history file 204 may be selected as decision criteria. JCLs to be such decision criteria may be stored in advance in a storage device or the like for each type of DB reorganization process.

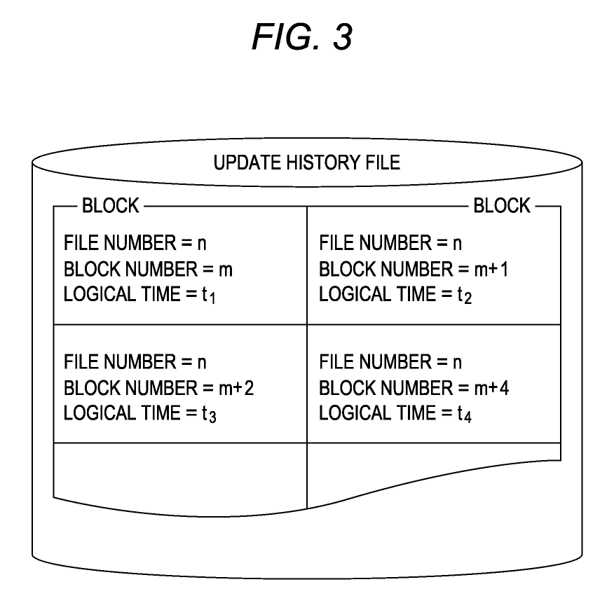

FIG. 3 is a diagram illustrated a configuration example of the update history file 202 according to the present embodiment.

The update history file 202 illustrated in FIG. 3 consists of one piece or two or more pieces of block data. An update history log or DB update log is stored in each piece of block data.

Each piece of block data has a file number used for identification of an update history file, a block number used for identification of the block data, and a logical time indicating a generation time of the block data.

The file number is a number attached to the update history file 202 in the order in which the update history file 202 is generated. When, for example, a plurality of change history files is remotely copied, the backup center 110 reads the change history file in the order of the file number to perform a reflection process of DB update logs and the DB reorganization process.

The block number is a number attached in the order in which the relevant block was generated. For example, the backup center 110 reads block data in the order of the block number to perform a JCL recorded in the block data as a DB update log.

The logical time is a logical time when the relevant block was generated. For example, the backup center 110 may read block data in the order of the logical time, instead of the block number, to perform a JCL recorded in the block data as an DB update log.

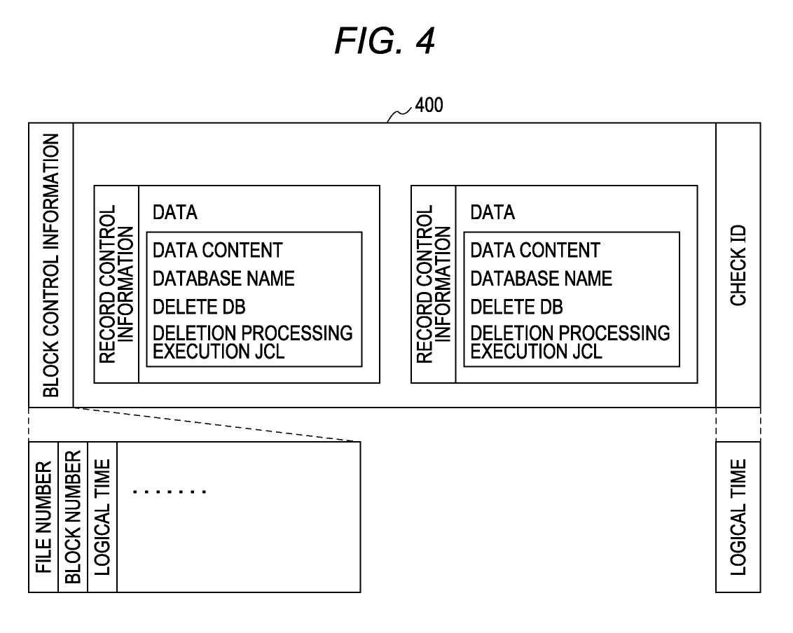

FIG. 4 is a diagram illustrating a configuration example of the block data illustrated in FIG. 3.

Block data 400 illustrated in FIG. 4 includes at least block control information, record information, and a check ID.

The block control information is management information of the block data 400. Therefore, the block control information includes the file number of the update history file to which the block data 400 belongs, the block number of the block data 400, the logical time when the block data was generated and the like.

The record information is information consisting of a record control part and a data part. Management information of the record information is stored in the record control part. For example, the type of data (type of update history, JCL and the like) in the data part is stored. An update history log generated during the DB update process in the regular center 100 or a DB update log of a JCL performed during the DB reorganization process is stored in the data part.

The configuration of the update history file 202 illustrated in FIG. 3 and FIG. 4 is one embodiment and is not intended to be limited to the configuration illustrated in FIG. 3 and FIG. 4. The update history file 202 only needs to contain a DB update log or update history log used in the present embodiment.

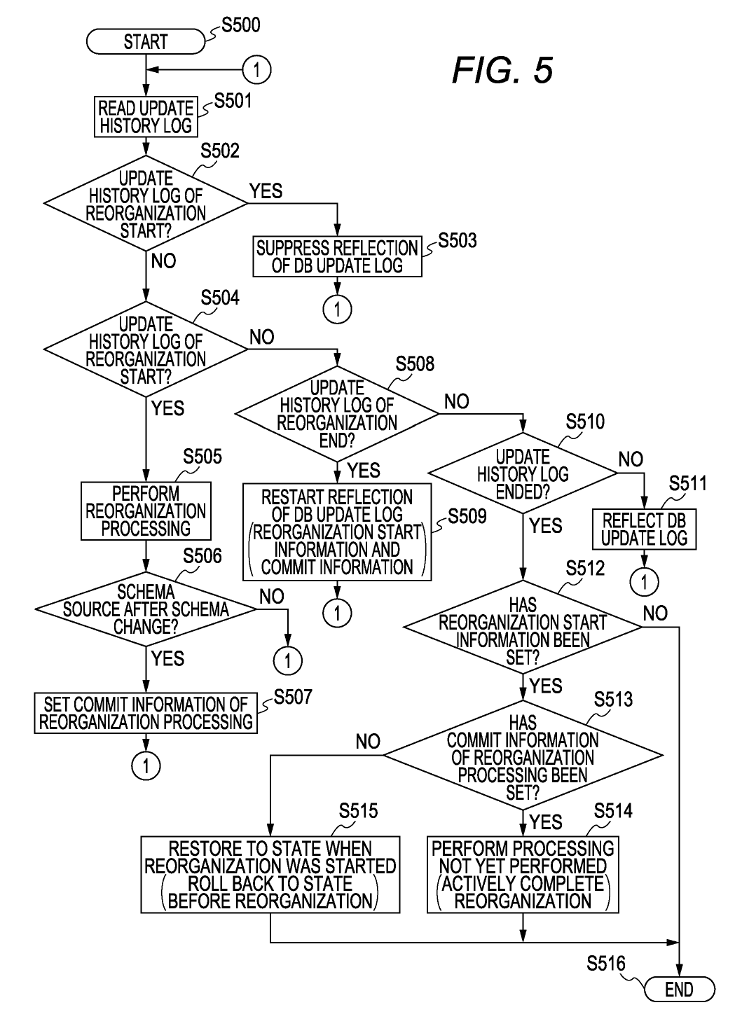

FIG. 5 is a flow chart illustrating the process in the backup center 110 according to the present embodiment.

When a remote copy of the update history file 202 is made by the regular center 100, the DB reflection control unit 111 starts a process illustrating below (step S500).

At step S501, the DB reflection control unit 111 references the update history file remotely copied to the DISK device 115 to read an update history log. Then, the DB reflection control unit 111 moves the process to step S502.

At step S502, the DB reflection control unit 111 determines whether or not the read update history log is an update history log containing reorganization start information recording the start of the DB reorganization process. If the DB reflection control unit 111 determines that the update history log is an update history log containing reorganization start information, the DB reflection control unit 111 moves the process to step S503. If the DB reflection control unit 111 determines that the update history log is not an update history log containing reorganization start information, the DB reflection control unit 111 moves the process to step S504.

At step S503, the DB reflection control unit 111 sets reorganization start information indicating the DB reorganization start to suppress a process (hereinafter, referred to as “DB update log reflection”) to perform the same update process on the DB 113 as that recorded in the DB update log.

In the present embodiment, for example, reorganization start information is stored at a predetermined position of memory or the like provided in the backup center 110. Another processing unit provided in the backup center 110 references the predetermined position of memory or the like to check whether or not reorganization start information is present and, if reorganization start information is present, stops the update process on the DB 113.

When the above setting is completed, the DB reflection control unit 111 moves the process to step S501. Then, the DB reflection control unit 111 reads the update history log of the next block number (or the logical time) of the update history log read last time.

At step S504, on the other hand, the DB reflection control unit 111 determines whether or not the update history log read at step S501 is an update history log related to DB reorganization. Then, if the DB reflection control unit 111 determines that the update history log is an update history log related to DB reorganization, the DB reflection control unit 111 moves the process to step S505.

At step S505, the DB reflection control unit 111 reads a JCL recorded in the update history log and performs the DB reorganization process according to the JCL. Then, the DB reflection control unit 111 moves the process to step S506.

At step S506, the DB reflection control unit 111 checks whether or not a record of a schema source after the schema change is present in the update history log. If the schema is recorded in the update history log, the DB reflection control unit 111 moves the process to step S507. If the schema is not recorded in the update history log, the DB reflection control unit 111 moves the process to step S501.

At step S507, the DB reflection control unit 111 sets information (hereinafter, referred to as “commit information”) indicating that even if a subsequent update history log is missing or a subsequent update history log does not contain DB reorganization process, the DB reorganization process will continue to a predetermined position of memory or the like provided in the backup center 110. Then, the DB reflection control unit 111 moves the process to step S501. The commit information in the present embodiment contains at least the type (for example, DB capacity expansion, defragmentation and the like) of DB reorganization process.

If, at step S504, the DB reflection control unit 111 determines that the update history log is not an update history log related to DB reorganization, the DB reflection control unit 111 moves the process to step S506.

At step S506, the DB reflection control unit 111 determines whether or not the update history log read at step S501 is an update history log containing reorganization end information recording the end of the DB reorganization process. Then, if the DB reflection control unit 111 determines that the update history log is an update history log containing reorganization end information, the DB reflection control unit 111 moves the process to step S509.

At step S509, the DB reflection control unit 111 deletes the reorganization start information set at step S503 and the commit information set at step S507 to restart reflection of the DB update log. Then, the DB reflection control unit 111 moves the process to step S501.

On the other hand, if, at step S508, the DB reflection control unit 111 determines that the update history log is not an update history log recording the end of DB reorganization process, the DB reflection control unit 111 moves the process to step S510.

At step S510, the DB reflection control unit 111 determines whether or not the update history log has finished. If there is any update history log to be read, the DB reflection control unit 111 determines that the update history log has not finished and moves the process to step S511 to reflect DB update logs recorded in the update history log. Then, the DB reflection control unit 111 moves the process to step S501.

On the other hand, if, at step S510, there is no update history log to be read, the DB reflection control unit 111 determines that the update history log has finished and moves the process to step S512. Then, the DB reflection control unit 111 references the predetermined position of memory or the like provided in the backup center 110 to check whether or not reorganization start information is present.

If reorganization start information is set, the DB reflection control unit 111 moves the process to step S513. If no reorganization start information is set, the DB reflection control unit 111 moves the process to step S516 to terminate the process.

At step S513, the DB reflection control unit 111 references the predetermined position of memory or the like provided in the backup center 110 to check whether or not commit information is present. Then, if commit information is set, the DB reflection control unit 111 moves the process to step S514. If no commit information is set, the DB reflection control unit 111 moves the process to step S515.

At step S514, the DB reflection control unit 111 references commit information to acquire the type of DB reorganization process. Then, the DB reflection control unit 111 acquires a necessary processing procedure from processing procedures stored in advance for each type of DB reorganization process to perform DB reorganization process according to the processing procedure.

For execution of initialization (step S204b) or reload (step S205b) illustrated in FIG. 2, for example, DB reorganization process is completed by performing such process. Then, the DB reflection control unit 111 moves the process to step S516 and end the process.

At step S515, the DB reflection control unit 111 stops the DB reorganization process and performs, for the process already performed, a process (rollback process) to restore the backup center 110 (the DB 113 and the directory 114) to a state when the DB reorganization process was started from the backup (for example, backup data of the DB 113 stored in the storage device 203 illustrated in FIG. 2) of the DB and an execution log recording the process already executed. Because recovery process of a state can be realized using a general technique, a detailed description thereof is omitted.

When the state when the DB reorganization process was started is restored, the DB reflection control unit 111 moves the process to step S516 to terminate the process.

While in the example illustrated in FIG. 2, a remote copy of the update history file 202 is made after the DB reorganization unit 102 is completed, a remote copy of the update history file 202 may be made for each of steps S200a to S206a or at regular intervals. When a disaster occurs, a remote copy of the update history file 202 may preferentially be made.

While in the example illustrated in FIG. 2, one update history file 202 is generated for each piece of the DB reorganization process, one update history file may be generated for each of steps S200a to S206a or for each predetermined step.

In the backup method according to the present embodiment, as described above, an update history file including update history logs and DB update logs is generated in the regular center 100 and a remote copy thereof is made to the backup center 110.

The backup center 110 determines whether or not the relevant DB reorganization process can be performed based on DB update logs in the update history file. Then, if the backup center 110 determines that the DB reorganization process can be performed, the backup center 110 performs the DB reorganization process according to the DB update logs.

Further, if a portion of the DB update logs is missing due to a disaster, the backup center 110 completes execution of the DB reorganization process by complementing operations presumed to have been recorded in the missing DB update logs.

Therefore, even if the regular center is hit by a disaster, for example, the backup center can independently complete DB reorganization process if a portion or all of DB update logs have been transferred to the backup center. Moreover, update history logs can be reflected after the DB reorganization process is completed.

That is, even if the regular center is hit by a disaster when DB reorganization in the regular center or that in the backup center is halfway through, the system on the side of the backup center can independently be restored to operate the system as an operating information processor by the backup center alone.

If minimum DB update logs needed for DB reorganization work are not available, inconsistency of the DB can be prevented because a state immediately before the DB reorganization is restored.

Moreover, an effect of eliminating a need to set up an independent system of operation to suppress reflection of update history logs can be achieved by unifying information of DB reorganization (DB update logs) in the regular center and update history logs for transfer to the backup center as an update history file.

Moreover, DB update logs in DB reorganization operations in the regular center can be transferred to the backup center in smaller units after each step or regularly and therefore, DB reorganization work can concurrently be done in the backup center.

Moreover, the need to convey save data backing up a DB and definition information to the backup center after each DB reorganization operation is eliminated and thus, a problem of a line load increased by remote transfer of save data can be resolved. Moreover, conveying costs and transfer costs of save data can be reduced.

Moreover, the need of a process to suppress reflection of update history logs by grasping/managing timing of reorganization being performed in the regular center is eliminated on the side of the backup center.

Since the update history file contains update history logs, the backup center can update the DB according to relevant update history logs after DB reorganization process is completed so that the amount of lost data when hit by a disaster can be minimized.

Even if the regular center is hit by a disaster halfway through reorganization and the process is interrupted, consistency of the DB on the side of the regular center can be guaranteed because the backup center can independently perform the same process as the relevant DB reorganization according to DB update logs.

What is claimed is:

1. A backup method of an information processor, comprising:
performing reorganization operation information generation processing to perform reorganization of a database by performing predetermined operations on the database and to generate reorganization operation information recording the predetermined operations before the reorganization operation information is stored in a first reorganization operation information storage unit; and
performing transmission processing to read reorganization operation information from the first reorganization operation information storage unit and to transmit the read reorganization operation information,
the transmission processing being performed in a regular center, which is an operating information processor equipped with the database to perform the information processing, and
performing reception processing to receive reorganization operation information transmitted from the regular center and to store the reorganization operation information in a second operation information storage unit;
performing reorganization continuation determination processing to read the reorganization operation information from the second operation information storage unit and to reference the predetermined operations recorded in the reorganization operation information to determine whether or not reorganization of the database performed in the regular center can be performed based on the predetermined operations; and
performing reorganization processing to perform reorganization of the database according to the predetermined operations recorded in the reorganization operation information when a determination is made in the reorganization continuation determination processing that reorganization of the database can be performed, and to complement any missing predetermined operation to perform reorganization if a portion of the predetermined operations recorded in the reorganization operation information is missing;
the reception processing, reorganization continuation determination processing and reorganization processing being performed in a backup center, which is a standby information processor of the regular center.

2. The backup method according to claim 1, wherein the reorganization operation information includes at least processing instructions on the database and definition information of the database.

3. The backup method according to claim 1, wherein the reorganization operation information is included in update history information recording update information of the database performed by the regular center.

4. The backup method according to claim 1, wherein the reorganization processing stops reflection processing of update information recorded in the update history information in the database.

5. The backup method according to claim 1, further comprising:
performing state recovery processing in which the database is restored to a state before the operations were performed if a determination is made in the reorganization continuation determination processing that reorganization of the database cannot be performed in the backup center and a portion or all of the predetermined operations recorded in the reorganization operation information have been performed.

6. The backup method according to claim 5, wherein the reorganization processing stops reflection processing of update information recorded in the update history information in the database during reorganization of the database.

7. A backup system comprising:
a regular center as an operating information processor performing information processing,
wherein the regular center includes:
a database storing data;
a reorganization operation information generation means to perform reorganization of the database by performing predetermined operations on the database and to generate reorganization operation information recording the predetermined operations before the reorganization operation information has been stored in a first reorganization operation information storage means; and
a transmission means to read reorganization operation information from the first reorganization operation information storage means and to transmit the read reorganization operation information; and
a backup center as a standby information processor of the regular center,
wherein the backup center includes:
a reception means for receiving reorganization operation information transmitted from the regular center and storing the reorganization operation information in a second operation information storage means;
a reorganization continuation determination means for reading the reorganization operation information from the second operation information storage means and for referencing the predetermined operations recorded in the reorganization operation information to determine whether or not reorganization of the database performed in the regular center can be performed based on the predetermined operations; and
a reorganization means for performing reorganization of the database according to the predetermined operations recorded in the reorganization operation information when a determination is made by the reorganization continuation determination means that reorganization of the database can be performed and for complementing any missing predetermined operation to perform reorganization if a portion of the predetermined operations recorded in the reorganization operation information is missing.

8. The backup system according to claim 7, wherein the reorganization operation information includes at least processing instructions on the database and definition information of the database.

9. The backup system according to claim 7, wherein the reorganization operation information is included in update history information recording update information of the database performed by the regular center.

10. The backup system according to claim 7, wherein the reorganization means stops reflection processing of update information recorded in the update history information in the database.

11. The backup system according to claim 7, further comprising:
a state recovery means by which the database is restored to a state before the operations were performed if a determination is made by the reorganization continuation determination means that reorganization of the database cannot be performed in the backup center and a portion or all of the predetermined operations recorded in the reorganization operation information have been already performed.

12. The backup system according to claim 11, wherein the reorganization means stops reflection processing of update information recorded in the update history information in the database during reorganization of the database.

13. A standby information processor for a regular center, which is an operating information processor having a database storing data to perform information processing, comprising:
a reception means for receiving reorganization operation information, which is information generated when the center performs predetermined operations on the database to reorganize the database and the center records the predetermined operations, the reception means storing the reorganization operation information in an operation information storage means;
a reorganization continuation determination means for reading the reorganization operation information from the operation information storage means and for referencing the predetermined operations recorded in the reorganization operation information to determine whether or not reorganization of the database performed in the regular center can be performed in the backup center based on the predetermined operations; and
a reorganization means for performing reorganization of the database according to the predetermined operations recorded in the reorganization operation information when a determination is made by the reorganization continuation determination means that reorganization of the database can be performed and for complementing the missing predetermined operation to perform reorganization of the database if a portion of the predetermined operations recorded in the reorganization operation information is missing.

14. The information processor according to claim 13, wherein the reorganization operation information includes at least processing instructions and definition information of the database.

15. The information processor according to claim 13, wherein the reorganization operation information is included in update history information recording update information of the database performed by the regular center.

16. The information processor according to claim 13, wherein the reorganization means stops reflection processing of update information recorded in the update history information in the database during reorganization of the database.

17. The information processor according to claim 13, further comprising:
a state recovery means by which the database is restored to a state before the operations were performed if a determination is made by the reorganization continuation determination means that reorganization of the database cannot be performed in the backup center and a portion or all of the predetermined operations recorded in the reorganization operation information have been already performed.

18. The information processor according to claim 17, wherein the reorganization means stops reflection processing of update information recorded in the update history information in the database during reorganization of the database.

19. An operating information processor performing any information processing, comprising:
a database storing any data;
a reorganization operation information generation means for performing reorganization of the database by performing predetermined operations on the database and for generating reorganization operation information recording the predetermined operations before the reorganization operation information have been stored in a reorganization operation information storage means; and
a transmission means for reading reorganization operation information from the reorganization operation information storage means and transmitting the read reorganization operation information to a backup center, which is a standby information processor, wherein whether or not reorganization of the database can be performed is determined based on the predetermined operations recorded in the reorganization operation information, and if a determination is made that reorganization of the database can be performed, reorganization of the database is performed based on the predetermined operations recorded in the reorganization operation information, and if a portion of the predetermined operations recorded in the reorganization operation information is missing, reorganization of the database is performed by complementing missing predetermined operations.
